(19) United States
(12) Patent Application Publication
(10) Pub. No.: US 2026/0064326 A1
(43) Pub. Date: Mar. 5, 2026

(54) CONVERSION OF NONTEXTUAL DATA TO TEXTUAL DATA FOR PRINTING

(71) Applicant: KYOCERA Document Solutions Inc., Osaka (JP)

(72) Inventor: Sam Chinh Co Tang Chan, Garden Grove, CA (US)

(21) Appl. No.: 18/819,578

(22) Filed: Aug. 29, 2024

(51) Int. Cl. G06F 3/12

(52) U.S. Cl. CPC G06F 3/1206; G06F 3/1253; G06F 3/127

(57) ABSTRACT

Systems and methods relate generally to printing. In a method, a first data file with audio data is received into a first hot folder of a printing device. Responsive to detection of receipt of the first data file, access to a plurality of files associated with the first hot folder is provided. The audio data is converted into corresponding text for providing a second data file with the text. Responsive to reaching an expiration time associated with the first hot folder for the first data file a second data file is transferred to a second hot folder of the printing device. While in the second hot folder, a user is allowed user editing of the second data file; and a second data file is subject to a configuration file associated with the second hot folder to convert the second data file into a print job.

### FIELD

The following description relates to printing. More particularly, the following description relates to converting nontextual data to textual data for printing.

### BACKGROUND

Generally, a “hot folder” serves as a staging area for items stored therein to be used for some purpose. A hot folder may be continuously monitored, so when files or other items are copied to, pasted to, dropped in, or otherwise put in association with such hot folder, such items are automatically processed according to a predefined configuration of such hot folder. However, one or more nontextual primary media data types such as images, graphic objects (including drawings, sketches and illustrations) animation sequences, audio, and video (singly and collectively “nontextual data”) may not be suitable or useable for direct printing thereof.

### SUMMARY

In accordance with one or more below described examples, a method relating generally to printing is disclosed. In such a method, a first data file with nontextual data is received into a first hot folder of a printing device for converting into corresponding text. The first data file is timestamped with a first timestamp responsive to receipt thereof. The first data file in the first hot folder is monitored for expiration using the first timestamp. Responsive to detection of receipt of the first data file, access to a plurality of files associated with the first hot folder for the printing of the text is triggered. The nontextual data is converted into the text for providing a second data file with the text. Responsive to reaching a first expiration time associated with the first hot folder for the first data file: transferring the second data file to a second hot folder of the printing device; timestamping the second data file with a second timestamp responsive to transfer thereof; monitoring the second data file in the second hot folder for expiration thereof using the second timestamp; allowing for user editing of the second data file; and accessing a configuration file associated with the second hot folder to convert the second data file into a print job. Responsive to reaching a second expiration time associated with the second hot folder for the second data file, the print job is printed by the printing device.

In accordance with one or more below described examples, a system relating generally to printing is disclosed. In such a system, a printing device has a memory configured to store program code; a processor coupled to the memory; and a printer engine configured for execution of printer operations. In combination and response to executing the program code, the printing device is configured to initiate operations for implementing a process for the printing. In the process, a first data file with nontextual data is received into a first hot folder of a printing device for converting into corresponding text. The first data file is timestamped with a first timestamp responsive to receipt thereof. The first data file in the first hot folder is monitored for expiration using the first timestamp. Responsive to detection of receipt of the first data file, access to a plurality of files associated with the first hot folder for the printing of the text is triggered. The nontextual data is converted into the text for providing a second data file with the text. Responsive to reaching a first expiration time associated with the first hot folder for the first data file: transferring the second data file to a second hot folder of the printing device; timestamping the second data file with a second timestamp responsive to transfer thereof; monitoring the second data file in the second hot folder for expiration thereof using the second timestamp; allowing for user editing of the second data file; and accessing a configuration file associated with the second hot folder to convert the second data file into a print job. Responsive to reaching a second expiration time associated with the second hot folder for the second data file, the print job is printed by the printing device.

Other features will be recognized from consideration of the Detailed Description and Claims, which follow.

### BRIEF DESCRIPTION OF THE DRAWINGS

Accompanying drawings show exemplary apparatus(es) and/or method(s). However, the accompanying drawings should not be taken to limit the scope of the claims, but are for explanation and understanding only.

FIGS. 1-1 through 1-4 are respective flow diagrams depicting corresponding examples of a printing flow for a printing device.

FIG. 2 is a flow diagram depicting an example of an editing flow for a printing flow of any of FIGS. 1-1 through 1-4.

FIG. 3 is a block diagram depicting an example of a networked system.

FIG. 4 is a pictorial diagram depicting an example of a network.

FIG. 5 is a block diagram depicting an example of a portable communication device.

FIG. 6 is a block diagram depicting an example of a multi-function printer (MFP).

FIG. 7 is a block diagram depicting an example of a computer system.

### DETAILED DESCRIPTION

In the following description, numerous specific details are set forth to provide a more thorough description of the specific examples described herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same number labels are used in different diagrams to refer to the same items; however, in alternative examples the items may be different.

Exemplary apparatus(es) and/or method(s) are described herein. It should be understood that the word “exemplary” is used herein to mean “serving as an example, instance, or illustration.” Any example or feature described herein as “exemplary” is not necessarily to be construed as preferred or advantageous over other examples or features.

Before describing the examples illustratively depicted in the several figures, a general introduction is provided to further understanding.

In a conventional document handling system, a printer or printer system may only receive a print job settings (“job settings”) may be obtained from a printer driver (“driver”). In another example, job settings might not be provided from a driver. In either example, a print job output may be delayed waiting for a print job in a shared print folder than having to be copied to a system folder for printing.

A printer system, like a computer, may operate under a network protocol. For a printer system, a Samba protocol, file transfer protocol (“FTP”), Server Message Block (“SMB”) protocol, Web Distributed Authoring and Versioning (“WebDAV”) extensions to a Hypertext Transfer Protocol (“HTTP”), or other printer system usable protocol may be used where one or more folders may be shared via such protocol.

A “hot folder” or “hotfolder” may be provided via a printer shared network folder, and this hot folder may have files associated with it. As described below in additional detail, hot folders are used to convert nontextual data into textual data for printing.

As described below in additional detail, a hot folder may be associated with a configuration file with printer job settings, including one or more default job settings. These settings may be used for printing with one or more user preferences, such as page sizing, stapling, punching, or other preference. Each hot folder of a printer system may have one or more defined file expiration times, such as for each type of supported file extension. An expiration period of time is an interval in which a printer system waits before a working file may be processed out of such hot folder.

With the above general understanding borne in mind, various configurations for systems, and methods therefor, for printing are generally described.

Reference will now be made in detail to examples which are illustrated in the accompanying drawings. In the following detailed description, numerous specific details are set forth in order to provide a thorough understanding of the following described implementation examples. It should be apparent, however, to one skilled in the art, that the implementation examples described below may be practiced without all the specific details given below. Moreover, the example implementations are not intended to be exhaustive or to limit scope of this disclosure to the precise forms disclosed, and modifications and variations are possible in light of the following teachings or may be acquired from practicing one or more of the teachings hereof. The implementation examples were chosen and described in order to best explain principles and practical applications of the teachings hereof to enable others skilled in the art to utilize one or more of such teachings in various implementation examples and with various modifications as are suited to the particular use contemplated. In other instances, well-known methods, procedures, components, circuits, and/or networks have not been described in detail so as not to unnecessarily obscure the described implementation examples.

For purposes of explanation, specific nomenclature is set forth to provide a thorough understanding of the various concepts disclosed herein. However, the terminology used herein is for the purpose of describing particular examples only and is not intended to be limiting. As used herein, the singular forms “a”, “an” and “the” are intended to include the plural forms as well, unless the context clearly indicates otherwise. As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. It will also be understood that the term “and/or” as used herein refers to and encompasses any and all possible combinations of one or more of the associated listed items. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof. It will also be understood that, although the terms first, second, etc., may be used herein to describe various elements, these elements should not be limited by these terms, as these terms are only used to distinguish one element from another.

Some portions of the detailed descriptions that follow are presented in terms of algorithms and symbolic representations of operations on data bits, including within a register or a memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those involving physical manipulations of physical quantities. Usually, though not necessarily, these quantities take the form of optical, electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers or memories into other data similarly represented as physical quantities within the computer system memories or registers or other such information storage, transmission or display devices.

Concepts described herein may be embodied as apparatus, method, system, or computer program product. Accordingly, one or more of such implementation examples may take the form of an entirely hardware implementation example, an entirely software implementation example (including firmware, resident software, and micro-code, among others) or an implementation example combining software and hardware, and for clarity any and all of these implementation examples may generally be referred to herein as a “circuit,” “module,” “system,” or other suitable terms. Furthermore, such implementation examples may be of the form of a computer program product on a computer-usable storage medium having computer-usable program code in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (“RAM”), a read-only memory (“ROM”), an erasable programmable read-only memory (“EPROM” or Flash memory), an optical fiber, a portable compact disc read-only memory (“CD-ROM”), an optical storage device, a transmission media such as those supporting the Internet or an intranet, or a magnetic storage device. The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (“RF”) or other means. For purposes of clarity by way of example and not limitation, the latter types of media are generally referred to as transitory signal bearing media, and the former types of media are generally referred to as non-transitory signal bearing media.

Computer program code for carrying out operations in accordance with concepts described herein may be written in an object-oriented programming language such as Java, Smalltalk, C++ or the like. However, the computer program code for carrying out such operations may be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (“LAN”) or a wide area network (“WAN”), or the connection may be made to an external computer (for example, through the Internet using an Internet Service Provider).

Systems and methods described herein may relate to an apparatus for performing the operations associated therewith. This apparatus may be specially constructed for the purposes identified, or it may include a general-purpose computer selectively activated or reconfigured by a computer program stored in the computer.

Notwithstanding, the algorithms and displays presented herein are not inherently related to any particular computer or other apparatus. Various general-purpose systems may be used with programs in accordance with the teachings herein, or it may prove convenient to construct a more specialized apparatus to perform the operations. In addition, even if the following description is with reference to a programming language, it should be appreciated that any of a variety of programming languages may be used to implement the teachings as described herein.

One or more examples are described below with reference to flowchart illustrations and/or block diagrams of methods, apparatus (including systems) and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the Figures illustrate the architecture, functionality, and operation of possible implementations of apparatuses (including systems), methods and computer program products according to various implementation examples. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

It should be understood that although the flow charts provided herein show a specific order of operations, it is understood that the order of these operations may differ from what is depicted. Also, two or more operations may be performed concurrently or with partial concurrence. Such variation will depend on the software and hardware systems chosen and on designer choice. It is understood that all such variations are within the scope of the disclosure. Likewise, software and web implementations may be accomplished with standard programming techniques with rule-based logic and other logic to accomplish the various database searching operations, correlation operations, comparison operations and decision operations. It should also be understood that the word “component” as used herein is intended to encompass implementations using one or more lines of software code, and/or hardware implementations, and/or equipment for receiving manual inputs.

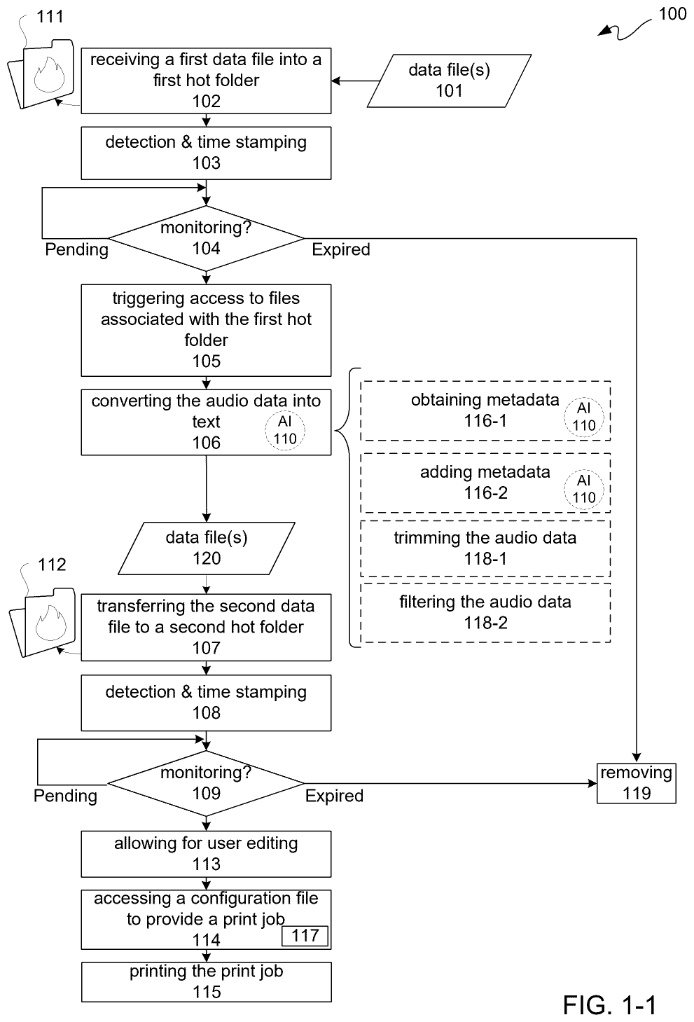

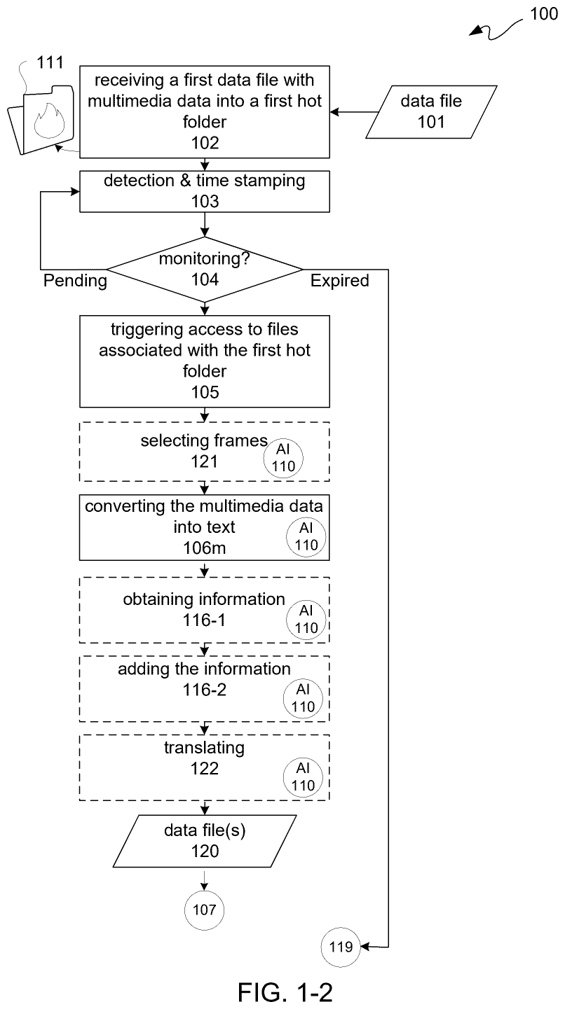

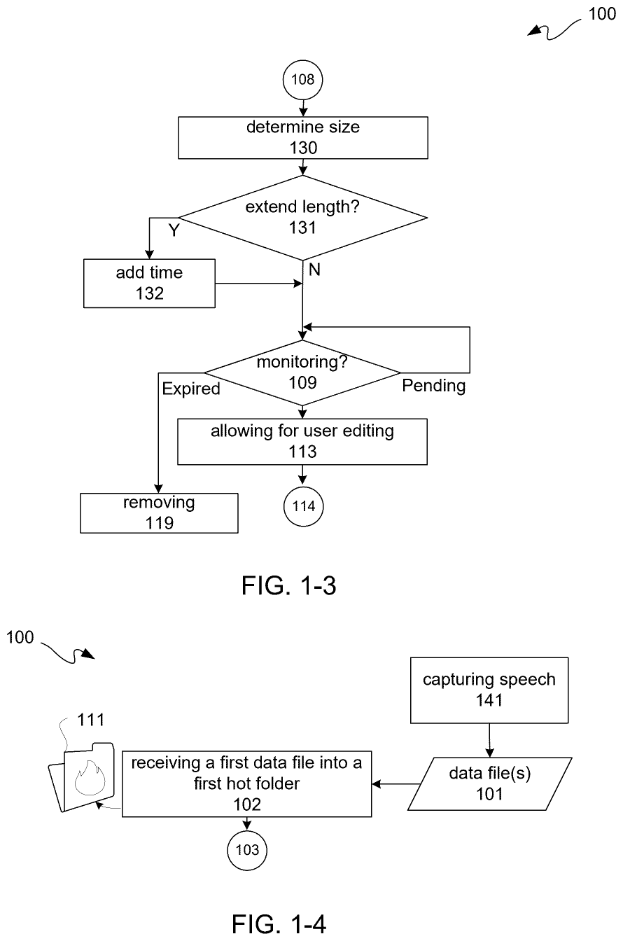

FIG. 1-1 is a flow diagram depicting an example of a printing flow 100 for a printing device. Such a printing device may be networked, as described below in additional detail.

One or more data files 101 having nontextual data may be received as a “first data file” into a hot folder or a “first hot folder” 111 at operation 102 of or accessible by such a printing device. In the example of FIG. 1-1, it is assumed that such a “first data file” has audio data included at least as part of such nontextual data. As described below in additional detail below, such audio data may be converted into corresponding text for subsequent printing by a printing device. Another “first data file” may follow for pipelined processing of multiple data files within a printing flow 100.

At operation 103, receipt of such a first data file 101 may be automatically detected by such a first hot folder 111. At operation 103, in response to such detection of receipt of a first data file 101 into such a first hot folder 111, such a first data file may be timestamped responsive to receipt. A timestamping operation and a detection operation 103 may be considered for clarity as simply a timestamping operation.

A hot folder may automatically respond to placement of content therein in order to timestamp each first data file received. Along those lines, multiple first data files may reside in corresponding hot folders by using a naming convention for multiple hot folders. However, by way of example for purposes of clarity and not limitation, a single first data file for a single first hot folder is described below in additional detail.

Monitoring operation 104 may be for determining whether a first data file 101 in a first hot folder 111 has expired. A timestamp of such a first data file may be used for determining whether a first data file 101 in such a first hot folder has expired based on a default or user setting of a time period or duration.

If at operation 104 it is determined that a first data file 101 has expired, then at operation 119 such a first data file 101 may be removed, deleted or purged from such a first hot folder 111. In this example, such a first data file 101 is removed from such a first hot folder 111 at operation 119.

During pendency of a first data file 101 in a first hot folder 111, at operation 105 access to files associated with such a first hot folder may be triggered for printing of audio data converted to text in this example. A template file and a database file may be associated with each first hot folder, as described below in additional detail.

Template file provides a layout for laying out source information of such first data file 101 for subsequent printing. A template file may be a static layout forcing information into a predefined layout. In another example, a template file may be a dynamic layout adjusting to information for laying out same for printing.

A database file may provide retrievable organized storage of additional or supplemental information which may be added to such source information for printing. Along those lines, a template file may be configured to absorb or adjust for addition of supplementation information to source information of a first data file.

Both a template file and a database file are described below in additional detail.

At operation 106 during pendency of a first data file 101 in a first hot folder 111, audio data, or more generally source data, may be converted from audio data into corresponding text by a speech-to-text conversion program to provide one or more data files. Optionally as part of operation 106, such speech-to-text conversion program may trim audio data, namely removing or reducing one or more audio gaps or silent sections, prior to conversion to text at operation 118-1. Further, optionally as part of operation 106, such a speech-to-text conversion program may filter audio data, namely filtering out or reducing background in such audio data, prior to conversion to text at operation 118-2.

In another example, a printing device has access to an artificial intelligence program. In this example, converting of audio data is by such an artificial intelligence application or program (“AI”) 110 to provide one or more data files. More particularly, AI 110 at operation 106 may create one or more data files, namely a “second data file”, 120 with such text. Again, there may be multiple instances of a “second data file” 120 for purposes of pipeline processing. AI 110 may be accessible via a public network by such a printing device.

Optionally at operation 116-1 as part of operation 106, AI 110 may obtain information from a public network, such as metadata for example in reference to text converted from audio. Such text may be used for generation of one or more queries in order to retrieve metadata regarding such text. Optionally at operation 116-2 as part of operation 106, AI 110 may add such metadata or information to such second data file. Such addition may be included in relation to or associated with corresponding text.

Optionally as part of operation 106, AI 110 may trim audio data, namely removing or reducing one or more audio gaps or silent sections, prior to conversion to text at operation 118-1. Further, optionally as part of operation 106, AI 110 may filter audio data, namely filtering out or reducing background in such audio data, prior to conversion to text at operation 118-2.

In response to reaching a first expiration time associated with a first hot folder 111 for first data file 101, at operation 107 a “second data file” 120 may be transferred to another hot folder or a “second hot folder” 112 of or accessible by such a printing device. This second data file 120 may be detected in such second hot folder 112 and timestamped with a “second timestamp” responsive to transfer thereof into such second hot folder.

Monitoring operation 109 may be for determining whether a second data file 120 in a second hot folder 112 has expired. A timestamp of such a second data file may be used for determining whether a second data file 120 in such a second hot folder has expired based on a default or user setting of a time period or duration.

If at operation 109 it is determined that a second data file 120 has expired, then at operation 119 such a second data file 120 may be removed, deleted or purged from such a second hot folder 112. In this example, such a second data file 120 is removed from such a second hot folder 112 at operation 119.

During pendency of a second data file 120 in a second hot folder 112, at operation 113 access to such second data file may be allowed for user editing thereof. A user may determine whether audio data was correctly converted for example and make correction edits to data in such second data file.

At operation 114, a configuration file, which may be associated with each second hot folder, may be accessed to convert such a second data file into a print job. A configuration file may have settings for creation and execution of a print job 117. Furthermore, in another example, at operation 113 a user may set one or more printer settings, which may be different from a set of default settings, of such configuration file. This allowing of user editing to include of configuration file may be via a webpage in order to set one or more printer settings for a printing device in print job 117.

At operation 115, such a print job 117 provided at operation 114 may be printed by a networked printing device. Responsive to reaching an expiration time associated with a corresponding second hot folder 120 for such a second data file corresponding to such print job, such second data file may be removed at operation 119.

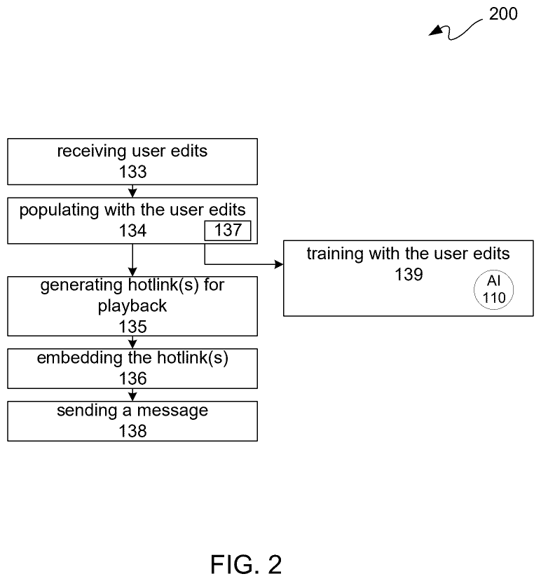

FIG. 1-2 is a flow diagram depicting another example of a printing flow 100 for a printing device. Such a printing device may be networked, as described below in additional detail. Printing flow 100 is similar to printing flow 100 of FIG. 1-1, but for a multimedia input. Accordingly, for purposes of clarity and not limitation, some description of FIG. 1-1 is not repeated.

One or more data files 101 may be received as a “first data file” into a hot folder or a “first hot folder” 111 at operation 102 of or accessible by such a printing device. In the example of FIG. 1-2, it is assumed that such a “first data file” has multimedia data, such as a combination of two or more of writing, audio, images, animations, or video data. As previously described, another “first data file” may follow for pipelined processing of multiple data files within a printing flow 100.

At operations 103, 104, and 119 are as previously described.

During pendency of a first data file 101 in a first hot folder 111, at operation 105 access to files associated with such a first hot folder may be triggered. A template file and a database file may be associated with each first hot folder, as described in additional detail elsewhere herein.

Optionally at operation 121, an AI 110 may select frames from video or animation data of multimedia data of a first data file 101. Frames may be selected as being representative of a scene for corresponding text. Additionally, selection of frames at operation 121 may include selection of one or more images in such multimedia data of such first data file.

At operation 106m, during pendency of a first data file 101 in a first hot folder 111, multimedia data, or more generally source data, may be converted where audio data thereof may be converted into corresponding text by AI 110 or a speech-to-text program to provide one or more data files as a second data file 120.

Furthermore, at operation 106m AI 110 may convert selected frames, such as of animation or video data or images, into corresponding text describing such frame to provide one or more data files as a second data file 120. Such corresponding text may be a description of information in a selected frame.

Additionally, first data file 101 may include writings or other text, which may be incorporated at operation 106m into such one or more data files provided as a second data file 120. Additionally, for music, assuming lyrics if present are incorporated from an audio to text conversion, of a first data file 101, such music may be converted to musical notation corresponding thereto.

Optionally, at operation 116-1, AI 110 may obtain other information, such as from a public network, as metadata or other information in association with text from audio, video, image, animation, music, or other data from a first data file 101. For example, text for a selected frame or an image of such a selected frame may be used by AI 110 to query a public network for metadata or other information associated with or in reference to such selected frame. Along those lines, metadata or other information for selected frames, or other multimedia data, may be added by AI 110 to such a second data file 120 at operation 116-2.

Optionally, at operation 122 AI 110 may translate text from one language to another language. Such translation may be performed by AI 110 or by AI 110 accessing a translation service via a public network.

One or more data files, namely a second data file 120 may be provided to operation 107 for further processing, as previously described. However, with respect to printing a print job 117 at operation 115, such a printing may include images associated with selected frames printed in correspondence with associated metadata to enhance a printable representation thereof.

FIG. 1-3 is a flow diagram depicting yet another example of a printing flow 100 for a printing device. Such a printing device may be networked, as described below in additional detail. Printing flow 100 is similar to printing flows 100 of FIGS. 1-1 and 1-2, but for the following differences. Accordingly, for purposes of clarity and not limitation, some description of FIG. 1-1 and FIG. 1-2 is not repeated.

From operation 108, at operation 130 a size of a second data file 120 may be determined. In an example, this determination may be by an operating system, and such information may be provided to AI 110 for extending a life of a second data file 120 in a second hot folder 112. At operation 131, it may be determined whether to extend length of time second data file 120 lives in a second hot folder 112 responsive to size of such file. In other words, a larger file may take more time for a user to edit, so for a file size in excess of a threshold amount, such as for example 5 megabytes, additional time may be added at operation 132 to a default expiration time setting of a second hot folder 112. For example, such additional time may be incrementally added for each 5 megabytes in excess of a threshold initial 5 megabytes setting.

Operations 109 and 113 may be performed as previously described, except possibly for some additional time for user editing at operation 113.

FIG. 1-4 is a flow diagram depicting still yet another example of a printing flow 100 for a printing device. Such a printing device may be networked, as described below in additional detail. Printing flow 100 is similar to printing flows 100 of FIGS. 1-1 through 1-3, but for the following differences. Accordingly, for purposes of clarity and not limitation, some description of FIGS. 1-1 through 1-3 is not repeated.

At operation 141, speech or other audio may be captured. For example, at operation 141 speech of a user may be captured via a microphone of or connected to a printing device to provide a first data file 101. Such first data file 101 may be provided to a first hot folder for operation 102, and operation 102 and subsequent operations may follow as previously described.

FIG. 2 is a flow diagram depicting an example of an editing flow 200, which may be used in a printing flow 100 of any of FIGS. 1-1 through 1-4. Accordingly, editing flow 200 of FIG. 2 is further described with simultaneous reference to FIGS. 1-1 through 1-4.

At operation 133, user edits may be received such as for operation 113. In an example, such user edits may be received via a web page. A configuration file may be accessed as previously described with reference to operation 114 as part of receiving such user edits at operation 133.

At operation 134, such configuration file may be populated with such user edits. In an example, user edits 137 are provided as training data for AI 110. AI 110 may be trained at operation 139 with user edits 137 for system improvement. As previously described user edits 137 may be instantiated in a print job 117.

At operation 135, a hotlink may be generated as a uniform resource locator, a quick-response code, or an identification code. Such hotlink or hotlinks (“hotlink(s)”) may be to access a first data file 101 for playback for listening by a user.

Furthermore, at operation 135, one or more other hotlink(s) may be as a uniform resource locator, a quick-response code, or an identification code. Such hotlink(s) may be to access a second data file 120 for playback for listening by a user, for purposes of comparison with playback of a source first data file 101 for such second data file.

At operation 136, such hotlinks for such first and second data files may be embedded in a location in such second data file responsive to a template file. Additionally, such hotlink(s) may be embedded in a message regarding a print job 117 about to be printed. At operation 138, a message may be sent as an email, a text or a push notice to a user prior to submission of a print job 117 for printing at operation 115.

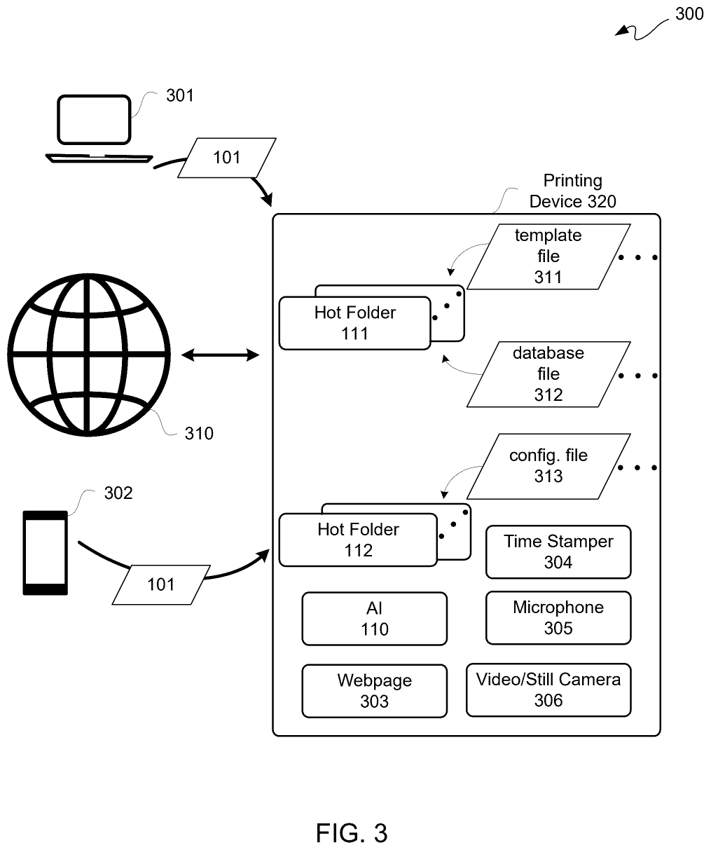

FIG. 3 is a block-flow diagram depicting an example of a networked system 300. Networked system 300 is further described with simultaneous reference to FIGS. 1-1 through 3.

A user device, such as for example a personal computer 301 or a smart mobile device 302, may be in communication with a printing device 320 for providing a first data file 101 thereto for subsequent conversion and printing as described herein. In an example, printing device 320 may be a multi-function printer or MFP.

Printing device 320 may have one or more first hot folders 111 and one or more second hot folders 112. Each of first hot folders 111 may have a corresponding template file 311 and a corresponding database file 312. For an example, AI 110 may obtain metadata and other information which may be temporarily stored in such a database file for use with a first data file 101 of a first hot folder 111. Template and database files have been previously described herein for a print job 117.

Each of second hot folders 112 may have a corresponding configuration file 313. A configuration file has been previously described herein for a print job 117.

Additionally, a printing device 320 may have a timestamper for timestamping files provided to hot folders 111 and 112. Additionally, printing device 320 may have or be coupled to a microphone 305 or a video/still camera 306 for capture of data for a first data file 101.

Printing device 320 may have a webpage 303 or may trigger a webpage 303 via a webserver in communication therewith. Printing device 320 may be networked to a public network, such as the Internet 310, or other public or private networks.

In this example, printing device 320 includes an AI 110. AI 110 having access to the Internet 310 may access one or more other Als for performing one or more operations as described herein. A user of a printing device 320 may have a subscription for performing services as described herein.

Because one or more of the examples described herein may be implemented using an information processing system, a detailed description of examples of each of a network (such as for a Cloud-based SaaS implementation), a computing system, a mobile device, and an MFP is provided. However, it should be understood that other configurations of one or more of these examples may benefit from the technology described herein.

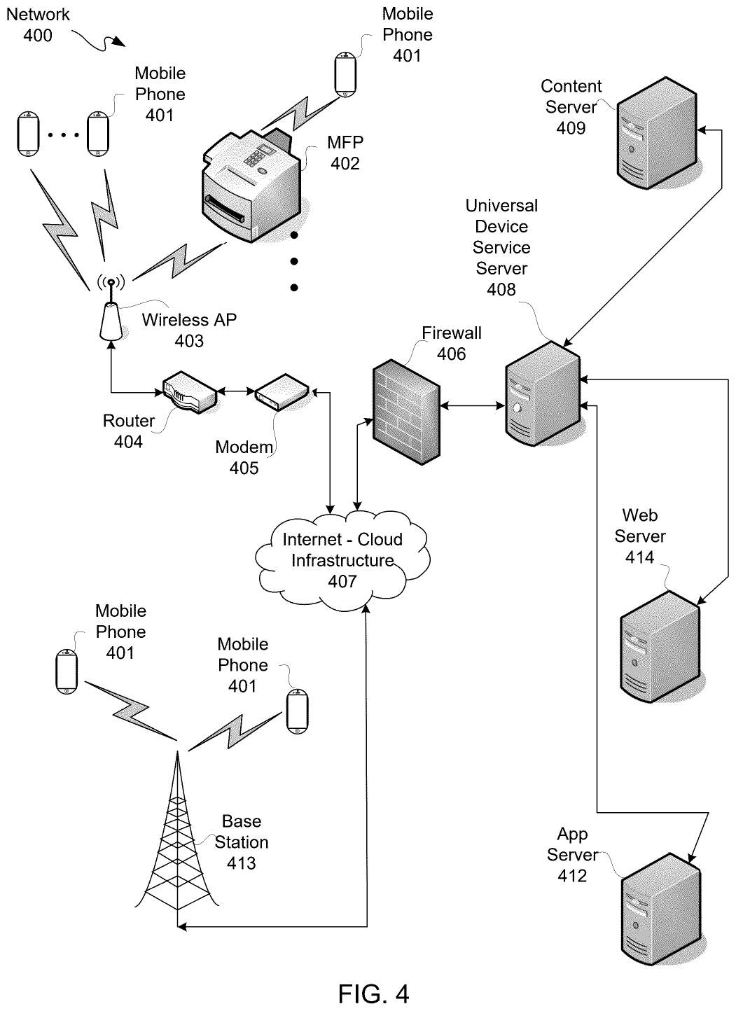

FIG. 4 is a pictorial diagram depicting an example of a network 400, which may be used to provide a SaaS platform for hosting a service or micro service for use by a user device, as described herein. Along those lines, network 400 may include one or more mobile phones, pads/tablets, notebooks, and/or other web-usable devices 401 in wired and/or wireless communication with a wired and/or wireless access point (“AP”) 403 connected to or of a wireless router. Furthermore, one or more of such web-usable wireless devices 401 may be in wireless communication with a base station 413.

Additionally, a desktop computer and/or a printing device, such as for example one or more multi-function printer (“MFPs”) 402, each of which may be web-usable devices, may be in wireless and/or wired communication to and from router 404. An MFP 402 may include at least one plasma head as previously described herein.

Wireless AP 403 may be connected for communication with a router 404, which in turn may be connected to a modem 405. Modem 405 and base station 413 may be in communication with an Internet-Cloud infrastructure 407, which may include public and/or private networks.

A firewall 406 may be in communication with such an Internet-Cloud infrastructure 407. Firewall 406 may be in communication with a universal device service server 408. Universal device service server 408 may be in communication with a content server 409, a web server 414, and/or an app server 412. App server 412, as well as a network 400, may be used for downloading an app or one or more components thereof for accessing and using a service or a micro service as described herein.

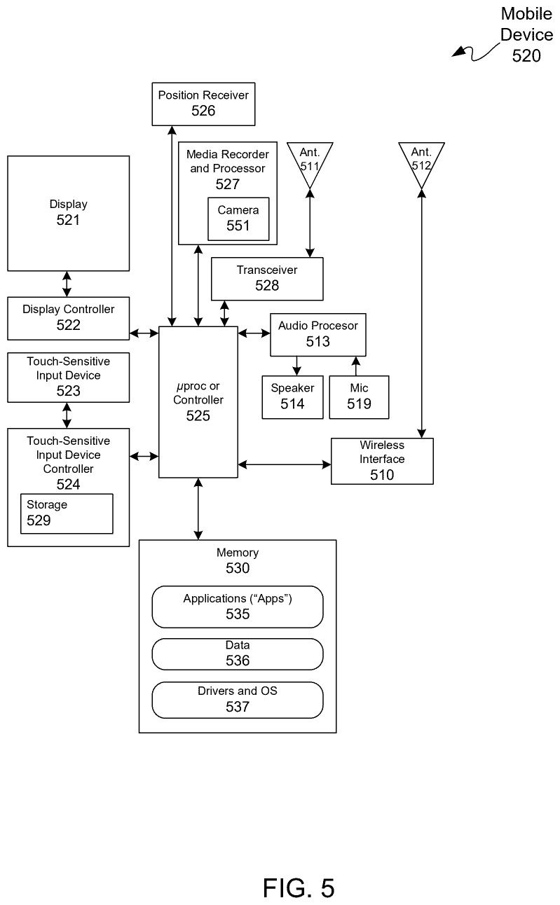

FIG. 5 is a block diagram depicting an example of a portable communication device (“mobile device”) 520. Mobile device 520 may be an example of a mobile device used to instruct a printing device.

Mobile device 520 may include a wireless interface 510, an antenna 511, an antenna 512, an audio processor 513, a speaker 514, and a microphone (“mic”) 519, a display 521, a display controller 522, a touch-sensitive input device 523, a touch-sensitive input device controller 524, a microprocessor or microcontroller 525, a position receiver 526, a media recorder 527, a cell transceiver 528, and a memory or memories (“memory”) 530.

Microprocessor or microcontroller 525 may be programmed to control overall operation of mobile device 520. Microprocessor or microcontroller 525 may include a commercially available or custom microprocessor or microcontroller.

Memory 530 may be interconnected for communication with microprocessor or microcontroller 525 for storing programs and data used by mobile device 520. Memory 530 generally represents an overall hierarchy of memory devices containing software and data used to implement functions of mobile device 520. Data and programs or apps, such as a mobile client application as described hereinabove, may be stored in memory 530.

Memory 530 may include, for example, RAM or other volatile solid-state memory, flash or other non-volatile solid-state memory, a magnetic storage medium such as a hard disk drive, a removable storage media, or other suitable storage means. In addition to handling voice communications, mobile device 520 may be configured to transmit, receive and process data, such as Web data communicated to and from a Web server, text messages (also known as short message service or SMS), electronic mail messages, multimedia messages (also known as MMS), image files, video files, audio files, ring tones, streaming audio, streaming video, data feeds (e.g., podcasts), and so forth.

In this example, memory 530 stores drivers, such as I/O device drivers, and operating system programs (“OS”) 537. Memory 530 stores application programs (“apps”) 535 and data 536. Data may include application program data. Apps 535 may include an XJDF reference file for a hot folder for communicating to a printer system in place of a printer driver.

I/O device drivers may include software routines accessed through microprocessor or microcontroller 525 or by an OS stored in memory 530. Apps, to communicate with devices such as the touch-sensitive input device 523 and keys and other user interface objects adaptively displayed on a display 521, may use one or more of such drivers.

Mobile device 520, such as a mobile or cell phone, includes a display 521. Display 521 may be operatively coupled to and controlled by a display controller 522, which may be a suitable microcontroller or microprocessor programmed with a driver for operating display 521.

Touch-sensitive input device 523 may be operatively coupled to and controlled by a touch-sensitive input device controller 524, which may be a suitable microcontroller or microprocessor. Along those lines, touching activity input via touch-sensitive input device 523 may be communicated to touch-sensitive input device controller 524. Touch-sensitive input device controller 524 may optionally include local storage 529.

Touch-sensitive input device controller 524 may be programmed with a driver or application program interface (“API”) for apps 535. An app may be associated with a service, as previously described herein, for use of a SaaS. One or more aspects of above-described apps may operate in a foreground or background mode.

Microprocessor or microcontroller 525 may be programmed to interface directly touch-sensitive input device 523 or through touch-sensitive input device controller 524. Microprocessor or microcontroller 525 may be programmed or otherwise configured to interface with one or more other interface device(s) of mobile device 520. Microprocessor or microcontroller 525 may be interconnected for interfacing with a transmitter/receiver (“transceiver”) 528, audio processing circuitry, such as an audio processor 513, and a position receiver 526, such as a global positioning system (“GPS”) receiver. An antenna 511 may be coupled to transceiver 528 for bi-directional communication, such as cellular and/or satellite communication.

Mobile device 520 may include a media recorder and processor 527, such as a still camera 551, a video camera, an audio recorder, or the like, to capture digital pictures, audio and/or video. Microprocessor or microcontroller 525 may be interconnected for interfacing with media recorder and processor 527. Image, audio and/or video files corresponding to the pictures, songs and/or video may be stored in memory 530 as data 536.

Mobile device 520 may include an audio processor 513 for processing audio signals, such as for example audio information transmitted by and received from transceiver 528. Microprocessor or microcontroller 525 may be interconnected for interfacing with audio processor 513. Coupled to audio processor 513 may be one or more speakers 514 and one or more microphones 519, for projecting and receiving sound, including without limitation recording sound, via mobile device 520. Audio data may be passed to audio processor 513 for playback. Audio data may include, for example, audio data from an audio file stored in memory 530 as data 536 and retrieved by microprocessor or microcontroller 525. Audio processor 513 may include buffers, decoders, amplifiers and the like.

Mobile device 520 may include one or more local wireless interfaces 510, such as a WIFI interface, an infrared transceiver, and/or an RF adapter. Wireless interface 510 may provide a Bluetooth adapter, a WLAN adapter, an Ultra-Wideband (“UWB”) adapter, and/or the like. Wireless interface 510 may be interconnected to an antenna 512 for communication. As is known, a wireless interface 510 may be used with an accessory, such as for example a hands-free adapter and/or a headset. For example, audible output sound corresponding to audio data may be transferred from mobile device 520 to an adapter, another mobile radio terminal, a computer, or another electronic device. In another example, wireless interface 510 may be for communication within a cellular network or another Wireless Wide-Area Network (WWAN).

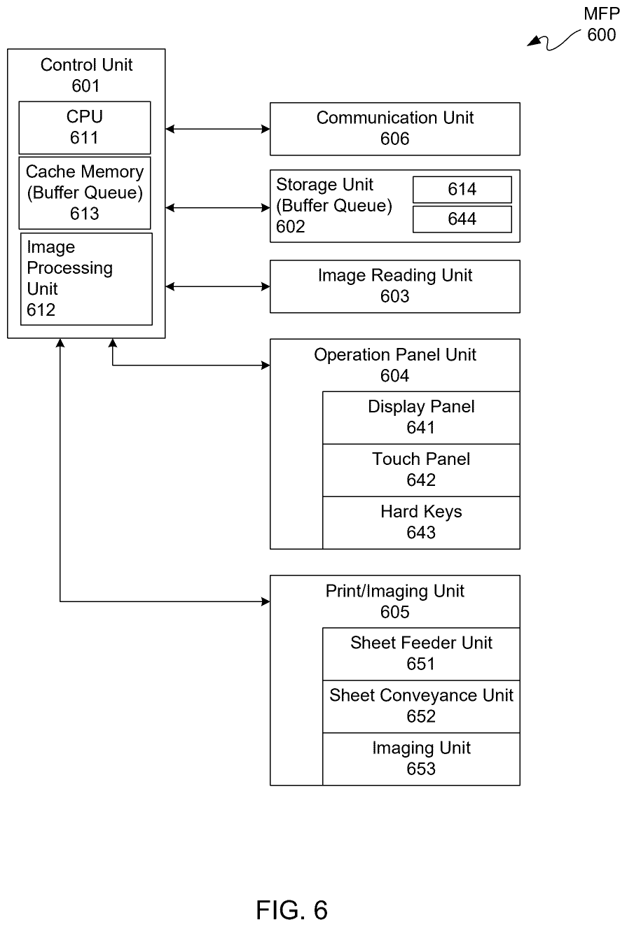

FIG. 6 is a block diagram depicting an example of a multi-function printer MFP 600. MFP 600 is provided for purposes of clarity by way of non-limiting example. MFP 600 is an example of an information processing system such as for handling a printer job.

MFP 600 includes a control unit 601, a storage unit 602, an image reading unit 603, an operation panel unit 604, a print/imaging unit 605, and a communication unit 606. Communication unit 606 may be coupled to a network for communication with other peripherals, mobile devices, computers, servers, and/or other electronic devices. Control unit 601 may include a CPU 611, an image processing unit 612, and cache memory 613.

Control unit 601 may be included with or separate from other components of MFP 600. Storage unit 602 may include ROM, RAM, and large capacity storage memory, such as for example an HDD or an SSD. Storage unit 602 may store various types of data and control programs, including without limitation a printer imaging pipeline program 614 and a printer job settings app 644. A buffer queue may be located in cache memory 613 or storage unit 602.

Operation panel unit 604 may include a display panel 641, a touch panel 642, and hard keys 643. Print/imaging unit 605 may include a sheet feeder unit 651, a sheet conveyance unit 652, and an imaging unit 653.

Generally, for example, for an MFP a copy image processing unit, a scanner image processing unit, and a printer image processing unit may all be coupled to respective direct memory access controllers for communication with a memory controller for communication with a memory. Many known details regarding MFP 600 are not described for purposes of clarity and not limitation.

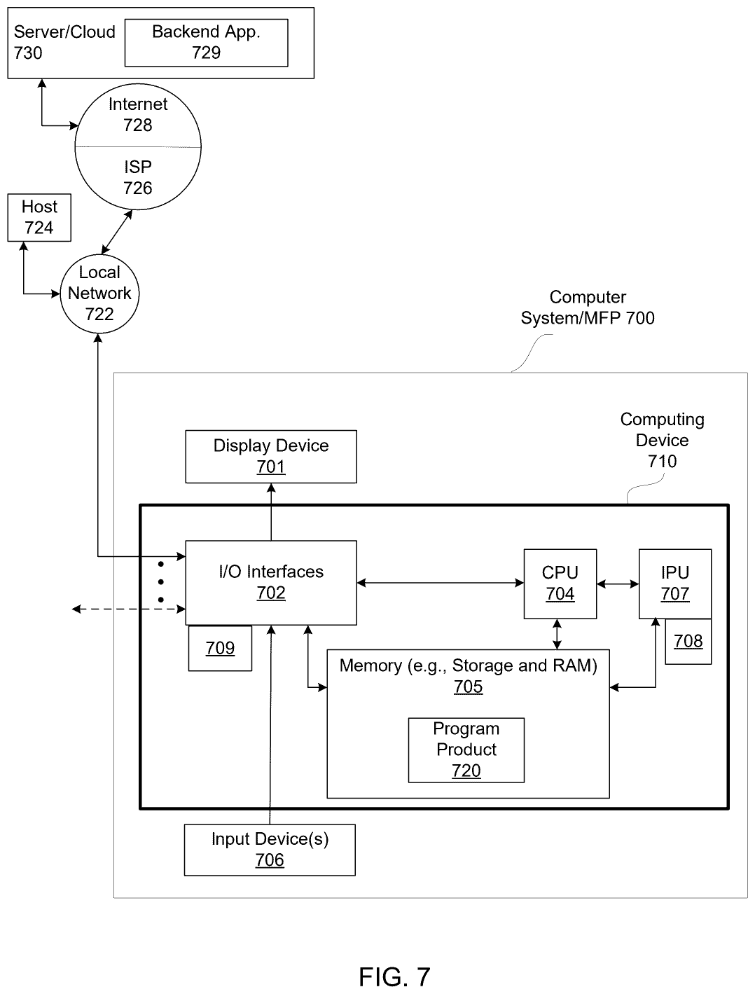

FIG. 7 is a block diagram depicting an example of a computer system or MFP 700 (“computer system”) upon which one or more aspects described herein may be implemented. Computer system 700 may include a programmed computing device 710 coupled to one or more display devices 701, such as Cathode Ray Tube (“CRT”) displays, plasma displays, Liquid Crystal Displays (“LCDs”), Light Emitting Diode (“LED”) displays, light emitting polymer displays (“LPDs”) projectors and to one or more input devices 706, such as a keyboard and a cursor pointing device. Other known configurations of a computer system may be used. Computer system 700 by itself or networked with one or more other computer systems 700 may provide an information handling/processing system.

Programmed computing device 710 may be programmed with a suitable operating system, which may include Mac OS, Java Virtual Machine, Real-Time OS Linux, Solaris, iOS, Darwin, Android Linux-based OS, Linux, OS-X, UNIX, or a Windows operating system, among other platforms, including without limitation an embedded operating system, such as VxWorks. Programmed computing device 710 includes a central processing unit (“CPU”) 704, one or more memories and/or storage devices (“memory”) 705, and one or more input/output (“I/O”) interfaces (“I/O interface”) 702. Programmed computing device 710 may optionally include an image processing unit (“IPU”) 707 coupled to CPU 704 and one or more peripheral cards 709 coupled to I/O interface 702. Along those lines, programmed computing device 710 may include graphics memory 708 coupled to optional IPU 707.

CPU 704 may be a type of microprocessor known in the art, such as available from IBM, Intel, ARM, and Advanced Micro Devices for example. CPU 704 may include one or more processing cores. Support circuits (not shown) may include busses, cache, power supplies, clock circuits, data registers, and the like.

Memory 705 may be directly coupled to CPU 704 or coupled through I/O interface 702. At least a portion of an operating system may be disposed in memory 705. Memory 705 may include one or more of the following: flash memory, random access memory, read only memory, magneto-resistive read/write memory, optical read/write memory, cache memory, magnetic read/write memory, and the like, as well as non-transitory signal-bearing media as described below. For example, memory 705 may include an SSD, which is coupled to I/O interface 702, such as through an NVMe-PCIe bus, SATA bus or other bus. Moreover, one or more SSDs may be used, such as for NVMe, RAID or other multiple drive storage for example.

I/O interface 702 may include chip set chips, graphics processors, and/or daughter cards, among other known circuits. In this example, I/O interface 702 may be a Platform Controller Hub (“PCH”). I/O interface 702 may be coupled to a conventional keyboard, network, mouse, camera, microphone, display printer, and interface circuitry adapted to receive and transmit data, such as data files and the like.

Programmed computing device 710 may optionally include one or more peripheral cards 709. An example of a daughter or peripheral card may include a network interface card (“NIC”), a display interface card, a modem card, and a Universal Serial Bus (“USB”) interface card, among other known circuits. Optionally, one or more of these peripherals may be incorporated into a motherboard hosting CPU 704 and I/O interface 702. Along those lines, IPU 707 may be incorporated into CPU 704 and/or may be of a separate peripheral card.

Programmed computing device 710 may be coupled to a number of client computers, server computers, or any combination thereof via a conventional network infrastructure, such as a company's Intranet and/or the Internet, for example, allowing distributed use. Moreover, a storage device, such as an SSD for example, may be directly coupled to such a network as a network drive, without having to be directly internally or externally coupled to programmed computing device 710. However, for purposes of clarity and not limitation, it shall be assumed that an SSD is housed in programmed computing device 710.

Memory 705 may store all or portions of one or more programs or data, including variables or intermediate information during execution of instructions by CPU 704, to implement processes in accordance with one or more examples hereof to provide a program product 720. Program product 720 may be for implementing portions of process flows, as described herein. Additionally, those skilled in the art will appreciate that one or more examples hereof may be implemented in hardware, software, or a combination of hardware and software. Such implementations may include a number of processors or processor cores independently executing various programs, dedicated hardware and/or programmable hardware.

Along those lines, implementations related to use of computing device 710 for implementing techniques described herein may be performed by computing device 710 in response to CPU 704 executing one or more sequences of one or more instructions contained in main memory of memory 705. Such instructions may be read into such main memory from another machine-readable medium, such as a storage device of memory 705. Execution of the sequences of instructions contained in main memory may cause CPU 704 to perform one or more process steps described herein. In alternative implementations, hardwired circuitry may be used in place of or in combination with software instructions for such implementations. Thus, the example implementations described herein should not be considered limited to any specific combination of hardware circuitry and software, unless expressly stated herein otherwise.

One or more program(s) of program product 720, as well as documents thereof, may define functions of examples hereof and can be contained on a variety of non-transitory tangible signal-bearing media, such as computer- or machine-readable media having code, which include, but are not limited to: (i) information permanently stored on non-writable storage media (e.g., read-only memory devices within a computer such as CD-ROM or DVD-ROM disks readable by a CD-ROM drive or a DVD drive); or (ii) alterable information stored on writable storage media (e.g., floppy disks within a diskette drive or flash drive or hard-disk drive or read/writable CD or read/writable DVD).

Computer readable storage media encoded with program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. In implementations, information downloaded from the Internet and other networks may be used to provide program product 720. Such transitory tangible signal-bearing media, when carrying computer-readable instructions that direct functions hereof, represent implementations hereof.

Along those lines the term “tangible machine-readable medium” or “tangible computer-readable storage” or the like refers to any tangible medium that participates in providing data that causes a machine to operate in a specific manner. In an example implemented using computer system 700, tangible machine-readable media are involved, for example, in providing instructions to CPU 704 for execution as part of programmed product 720. Thus, a programmed computing device 710 may include programmed product 720 embodied in a tangible machine-readable medium. Such a medium may take many forms, including those describe above.

The term “transmission media”, which includes coaxial cables, conductive wire and fiber optics, including traces or wires of a bus, may be used in communication of signals, including a carrier wave or any other transmission medium from which a computer can read. Transmission media can also take the form of acoustic or light waves, such as those generated during radio-wave and infra-red data communications.

Various forms of tangible signal-bearing machine-readable media may be involved in carrying one or more sequences of one or more instructions to CPU 704 for execution. For example, instructions may initially be carried on a magnetic disk or other storage media of a remote computer. The remote computer can load the instructions into its dynamic memory and send such instructions over a transmission media using a modem. A modem local to computer system 700 can receive such instructions on such transmission media and use an infra-red transmitter to convert such instructions to an infra-red signal. An infra-red detector can receive such instructions carried in such infra-red signal and appropriate circuitry can place such instructions on a bus of computing device 710 for writing into main memory, from which CPU 704 can retrieve and execute such instructions. Instructions received by main memory may optionally be stored on a storage device either before or after execution by CPU 704.

Computer system 700 may include a communication interface as part of I/O interface 702 coupled to a bus of computing device 710. Such a communication interface may provide a two-way data communication coupling to a network link connected to a local network 722. For example, such a communication interface may be a local area network (“LAN”) card to provide a data communication connection to a compatible LAN. Wireless links may also be implemented. In any such implementation, a communication interface sends and receives electrical, electromagnetic or optical signals that carry digital and/or analog data and instructions in streams representing various types of information.

A network link to local network 722 may provide data communication through one or more networks to other data devices. For example, a network link may provide a connection through local network 722 to a host computer 724 or to data equipment operated by an Internet Service Provider (“ISP”) 726 or another Internet service provider. ISP 726 may in turn provide data communication services through a world-wide packet data communication network, the “Internet” 728. Local network 722 and the Internet 728 may both use electrical, electromagnetic or optical signals that carry analog and/or digital data streams. Data carrying signals through various networks, which carry data to and from computer system 700, are exemplary forms of carrier waves for transporting information.

Wireless circuitry of I/O interface 702 may be used to send and receive information over a wireless link or network to one or more other devices' conventional circuitry such as an antenna system, an RF transceiver, one or more amplifiers, a tuner, one or more oscillators, a digital signal processor, a CODEC chipset, memory, and the like. In some implementations, wireless circuitry may be capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, WIFI (such as IEEE 802.11a, IEEE 802.11b, IEEE 802.11g and/or IEEE 802.11n), Bluetooth, Wi-MAX, voice over Internet Protocol (VOIP), near field communication protocol (NFC), a protocol for email, instant messaging, and/or a short message service (SMS), or any other suitable communication protocol. A computing device can include wireless circuitry that can communicate over several different types of wireless networks depending on the range required for the communication. For example, a short-range wireless transceiver (e.g., Bluetooth), a medium-range wireless transceiver (e.g., WIFI), and/or a long range wireless transceiver (e.g., GSM/GPRS, UMTS, CDMA2000, EV-DO, and LTE/LTE-Advanced) can be used depending on the type of communication or the range of the communication.

Computer system 700 can send messages and receive data, including program code, through network(s) via a network link and communication interface of I/O interface 702. In the Internet example, a server 730 might transmit a requested code for an application program through Internet 728, ISP 726, local network 722 and I/O interface 702. A server/Cloud-based system 730 may include a backend application for providing one or more applications or services as described herein. Received code may be executed by processor 704 as it is received, and/or stored in a storage device, or other non-volatile storage, of memory 705 for later execution. In this manner, computer system 700 may obtain application code in the form of a carrier wave.

While the foregoing describes exemplary apparatus(es) and/or method(s), other and further examples in accordance with the one or more aspects described herein may be devised without departing from the scope hereof, which is determined by the claims that follow and equivalents thereof. Claims listing steps do not imply any order of the steps. Trademarks are the property of their respective owners.

What is claimed is:

1. A method for a printing device, comprising:
receiving a first data file with nontextual data into a first hot folder of the printing device for converting into corresponding text;
timestamping the first data file with a first timestamp responsive to receipt thereof;
monitoring the first data file in the first hot folder for expiration using the first timestamp;
responsive to detection of the receiving, triggering access to a plurality of files associated with the first hot folder for the printing of the text;
converting the nontextual data into the text for providing a second data file with the text;
responsive to reaching a first expiration time associated with the first hot folder for the first data file:
transferring the second data file to a second hot folder of the printing device;
timestamping the second data file with a second timestamp responsive to transfer thereof;
monitoring the second data file in the second hot folder for expiration thereof using the second timestamp;
allowing for user editing of the second data file; and
accessing a configuration file associated with the second hot folder to convert the second data file into a print job; and
responsive to reaching a second expiration time associated with the second hot folder for the second data file, printing the print job by the printing device.

2. The method according to claim 1, wherein the nontextual data includes audio data, and wherein:
the printing device has access to an artificial intelligence program; and
the converting of the audio data is by the artificial intelligence program into the text for providing the second data file with the text.

3. The method according to claim 2, wherein the artificial intelligence program is accessible via a public network by the printing device, the method further comprising:
allowing for the user editing to include of the configuration file via a webpage to set one or more printer settings for the printing device in the print job.

4. The method according to claim 3, further comprising:
obtaining information from the public network by the artificial intelligence program as metadata in reference to the text; and
adding the information by the artificial intelligence program to the second data file in association with the text;
wherein the plurality of files include:
a template file for laying out the text and the information for subsequent conversion of the second data file to the print job; and
a database file for storing the information.

5. The method according to claim 4, wherein:
the audio data includes music; and
the text includes musical notation corresponding to the music.

6. The method according to claim 4, wherein the text, the metadata and the information respectively is first text, first metadata and first information, and wherein the first data file includes video data in addition to the audio data; the method further comprising:
converting the video data into corresponding second text for selected frames thereof by the artificial intelligence program;
obtaining second information from the public network by the artificial intelligence program as second metadata in reference to the selected frames; and
adding the second text by the artificial intelligence program into the second data file;
wherein the second text includes second metadata associated with the video frames selected;
deleting the first data file in the first hot folder responsive to the first expiration; and
deleting the second data file in the second hot folder responsive to the second expiration.

7. The method according to claim 6, wherein the printing includes images associated with the selected frames printed in correspondence with the second metadata to enhance a printable representation thereof.

8. The method according to claim 4, wherein the text, the metadata and the information respectively is first text, first metadata and first information, and wherein the first data file includes video data in addition to the audio data; the method further comprising:
converting the image data into corresponding second text by the artificial intelligence program;
adding the second text by the artificial intelligence program into the second data file;
wherein the second text includes second metadata associated with the image data;
deleting the first data file in the first hot folder responsive to the first expiration; and
deleting the second data file in the second hot folder responsive to the second expiration.

9. The method according to claim 8, wherein the printing includes images associated with the image data printed in correspondence with the second metadata to enhance a printable representation thereof.

10. The method according to claim 4, further comprising translating the text from a first language to a second language by the artificial intelligence program.

11. The method according to claim 4, further comprising:
receiving user edits via the webpage;
populating the configuration file with the user edits for access by the artificial intelligence program; and
training the artificial intelligence program with the user edits.

12. The method according to claim 4, further comprising capturing speech of a user via a microphone to provide the first data file.

13. The method according to claim 12, further comprising sending a message as an email, a text or a push notice to the user prior to submission of the print job for the printing thereof.

14. The method according to claim 13, further comprising:
generating a hotlink as a uniform resource locator, a quick-response code, or an identification code to access the first data file for playback; and
embedding the hotlink in the message.

15. The method according to claim 14, further comprising:
determining size of the second data file; and
extending length of the second expiration time responsive to the size.

16. The method according to claim 12, further comprising:
generating a first hotlink as a first uniform resource locator, a first quick-response code, or a first identification code to access the first data file for playback;
generating a second hotlink as a second uniform resource locator, a second quick-response code, or a second identification code to access the second data file for playback; and
embedding the first hotlink and the second hotlink in the second data file responsive to the template file.

17. The method according to claim 16, further comprising:
trimming the audio data of the first data file to reduce one or more audio gaps prior to the converting into the text; and
filtering background noise in the audio data of the first data file prior to the converting into the text.

18. A system, comprising:
a printing device having:
a memory configured to store program code;
a processor coupled to the memory; and
a printer engine configured for execution of printer operations;
wherein, in combination and response to executing the program code, the printer system is configured to initiate operations for implementing a process for printing, the process including:
receiving a first data file with nontextual data into a first hot folder of the printing device for converting into corresponding text;
timestamping the first data file with a first timestamp responsive to receipt thereof;
monitoring the first data file in the first hot folder for expiration using the first timestamp;
responsive to detection of the receiving, triggering access to a plurality of files associated with the first hot folder for the printing of the text;
converting the nontextual data into the text for providing a second data file with the text;
responsive to reaching a first expiration time associated with the first hot folder for the first data file:
transferring the second data file to a second hot folder of the printing device;
timestamping the second data file with a second timestamp responsive to transfer thereof;
monitoring the second data file in the second hot folder for expiration thereof using the second timestamp;
allowing for user editing of the second data file; and
accessing a configuration file associated with the second hot folder to convert the second data file into a print job; and
responsive to reaching a second expiration time associated with the second hot folder for the second data file, printing the print job by the printing device.

19. The system according to claim 18, wherein the nontextual data includes audio data, and wherein:
the printing device has access to an artificial intelligence program; and
the converting of the audio data is by the artificial intelligence program into the text for providing the second data file with the text.

20. The system according to claim 19, wherein the artificial intelligence program is accessible via a public network by the printing device, the method further comprising:
obtaining information from the public network by the artificial intelligence program as metadata in reference to the text;
adding the information by the artificial intelligence program to the second data file in association with the text;
wherein the plurality of files include:
a template file for laying out the text and the information for subsequent conversion of the second data file to the print job; and
a database file for storing the information; and
allowing for the user editing to include of the configuration file via a webpage to set one or more printer settings for the printing device in the print job.
